(19) United States
(12) Patent Application Publication
(10) Pub. No.: US 2019/0358112 A1
(43) Pub. Date: Nov. 28, 2019

(54) DECOMPRESSION CHAIR

(71) Applicant: Michael Joseph Grens, Elgin, IL (US)

(72) Inventor: Michael Joseph Grens, Elgin, IL (US)

(21) Appl. No.: 15/986,808

(22) Filed: May 23, 2018

(51) Int. Cl. A61H 1/02; A47C 7/54; A47C 7/40; A47C 31/00; A61G 15/00; A61H 7/00

(52) U.S. Cl. CPC A61H 1/0229; A61H 2201/0103; A47C 7/402; A47C 31/008; A61G 15/007; A61H 7/00; A61H 2201/0149; A61H 2203/0425; A61H 2201/1607; A61H 2201/1621; A61H 2201/1623; A61H 2201/163; A61H 2201/1635; A61H 2201/123; A61G 2200/52; A47C 7/54

(57) ABSTRACT

The decompression chair will allow a user to help straighten and support their back for pain relief while they sit. The decompression chair carefully stretches and aligns the body by pulling back the shoulders, supporting the lumbar region, holding the neck and lower legs and raising the upper back. The decompression chair of the present invention has an adjustable back rest for optimal angles and collapses for easy storage at home. Adjustable straps, back supports and foot pads ensure an optimal fit.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of chiropractic therapy devices and more specifically relates to an adjustable traction or decompression chair for use at home.

### 2. DESCRIPTION OF THE RELATED ART

Sitting and standing for long periods of time can aggravate back pain and cause uncomfortable spinal compressions that can be difficult to relieve. Two methods commonly used are traction or decompression chairs and inversion tables. Inversion tables put stress on the ankles as the user is suspended upside down. Also, blood rushes to the head and this can be uncomfortable for the user.

Traction or decompression chairs are adjustable chairs that assist chiropractors in spinal correction and relieving pressure on the user's posture. The chair supports the neck and shoulders while relieving pressure on the legs and lower extremities in order to correct posture easily. There are great benefits of using these chairs. Benefits may include: muscles may feel more relaxed; less tension; circulation may improve; posture correction; flexibility may increase; improved muscle strength; and better joint mobility.

Most people must go to a doctor's office to use one of these chairs but some of these chairs become uncomfortable quickly. To get the maximum benefit from these chairs, two 30 minute sessions per day are often recommended. This is inconvenient for most people who must go to a doctor's office to use one of these chairs. Also, many of these chairs are not foldable or storable.

Ideally, a traction or decompression chair should provide comfortable and gentle traction to the spinal column while the user is seated, be convenient to use at home and, yet would operate reliably and be manufactured at a modest expense.

### BRIEF SUMMARY OF THE INVENTION

In view of the foregoing disadvantages inherent in the known traction or decompression chair art, the present invention provides a novel decompression chair. The general purpose of the present invention, which will be described subsequently in greater detail is to provide a novel and comfortable decompression chair that can be used at home and then folded and stored away when not needed.

Sitting and standing for long periods of time can aggravate back pain and cause uncomfortable spinal compressions that can be difficult to relieve. Your spine, in profile, should look like a gently curving highway. However, many of us look more like a dirt road through hill country.

With the decompression chair, you can help straighten and support your back for pain relief while you sit. The decompression chair carefully stretches and aligns the body by pulling back the shoulders, supporting the lumbar region, holding the neck and lower legs and raising the upper back.

Just like the traction chairs found at a chiropractor's office, the decompression chair of the present invention takes pressure off the spinal cord to help straighten the back and increase blood flow to compressed discs. Plus, the decompression chair features adjustable straps, back supports, and foot pads for incredible comfort and relaxation for users of all shapes and sizes.

The decompression chair of the present invention allows the user to get the same benefits as a chiropractor's specialty chair at home. Unlike other decompression chairs that become uncomfortable quickly, a user can stay seated in the decompression chair of the present invention as long as needed due to its' intelligent ergonomic design.

The decompression chair of the present invention has an adjustable back rest for optimal angles and collapses for easy storage at home. Adjustable straps, back supports and foot pads ensure an optimal fit. The present invention can help soothe back and spinal discomfort, improve posture and relieve pain just by sitting.

The decompression chair has a 135 degree angle with a rolling back rest. The back rest has contour sections for neck traction and lumbar support. The seat height is a fixed 18 inches to the seat pad. The upper back rest is adjustable either through an electric, pneumatic, hydraulic or mechanical piston to raise or lower it with respect to the seat. Raising the back rest takes pressure off the spinal cord and helps straighten and increase blood flow to compressed discs.

The present invention holds significant improvements and serves as a decompression chair. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a decompression chair, constructed and operative according to the teachings of the present invention.

FIG. 1 shows a perspective view illustrating a front view of a decompression chair according to the present invention.

FIG. 2 is a perspective view illustrating a cut away side view according to the first embodiment of the present invention of FIG. 1.

FIG. 3 is a perspective view illustrating a rear side view according to a second embodiment of the present invention of FIG. 1.

FIG. 4 is a perspective view illustrating a rear view according to the second embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a decompression chair and more particularly to a chiropractic decompression chair for use at home to improve the posture and relieve pressure on the spinal column.

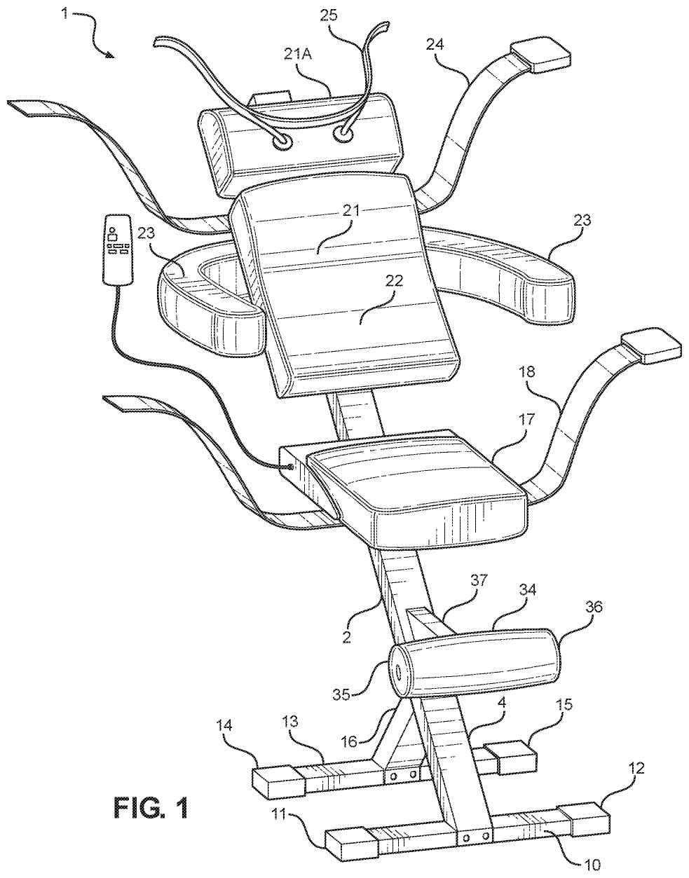

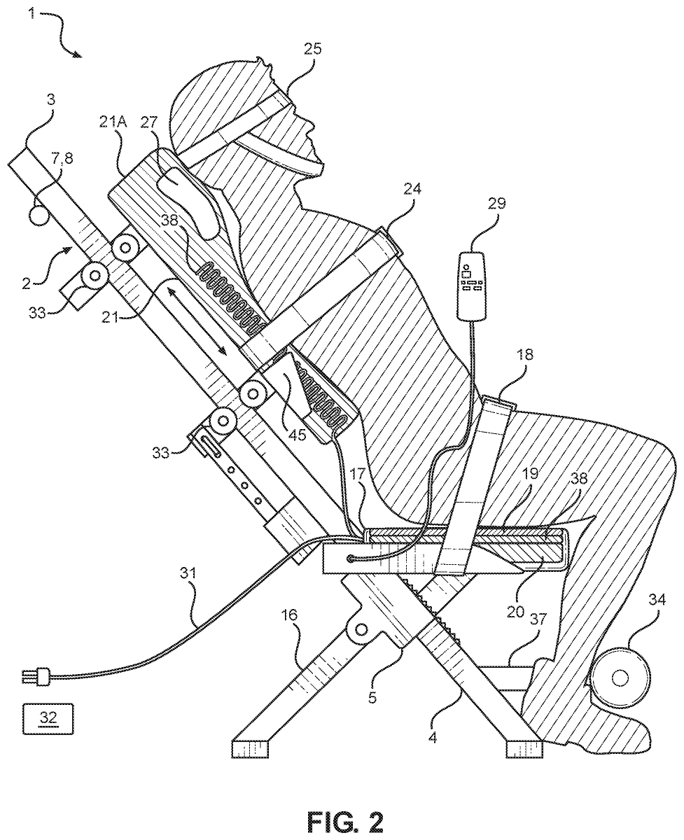

Referring to the drawings by numerals of reference there is shown in FIGS. 1-4, a decompression chair 1 is shown having an elongated main support member 2 which includes a length extending between a proximal end 3 and a distal end 4 (See FIG. 2). The decompression chair 1 also has a first stabilizer bar 10 having a length between a proximal end 11 and a distal end 12 (See FIG. 1). The first stabilizer bar 10 is connected to the distal end 4 of the elongated main support member 2, is oriented perpendicular to the elongated main support member 2 and is adapted to engage a supporting surface.

The decompression chair 1 has a second stabilizer bar 13 having a length between a proximal end 14 and a distal end 15 and is connected to a center portion 5 of the elongated main support member 2 via an elongated extension member 16, is oriented perpendicular thereto and is adapted to engage the supporting surface spaced from the first stabilizer bar 10 in order to hold the decompression chair 1 in a stable position relative to the supporting surface (See FIG. 1).

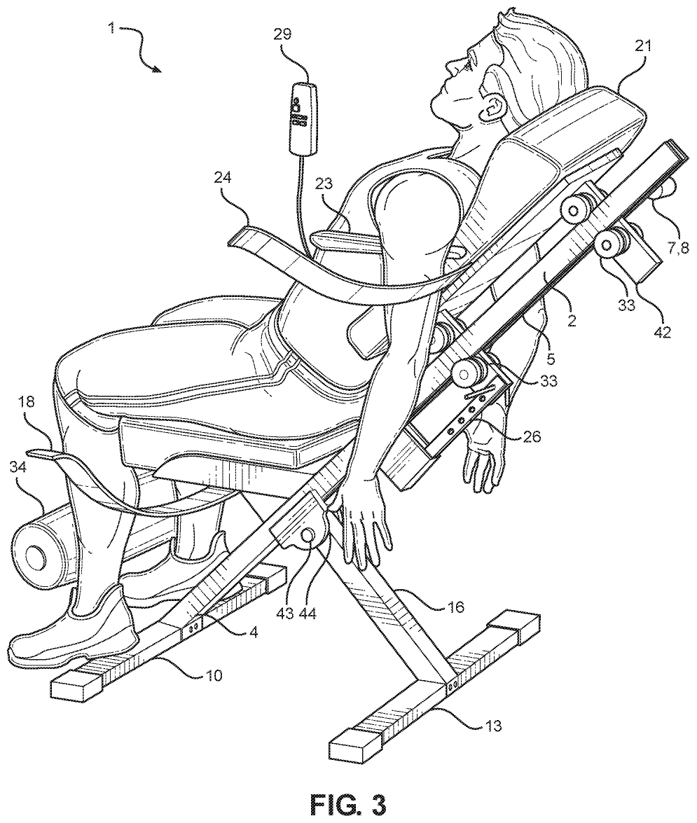

The elongated extension member 16 is pivotally connected to the middle portion of the elongated main support member 2. The elongated extension member 16 is pivotally connected to the center portion 5 of the elongated main support member 2 by a pin 43 and a stop member 44 (See FIG. 3) such that an angle formed therebetween is adjustable between an open in-use position and a folded position suitable for storage. Stop member 44 is a pair of flanges in which the upper end of extension member 16 is hinged by the pin 43 so as to allow it to fixedly extend when in use and be folded for ease of storage.

A foot support member 34 having a length between a proximal end 35 and a distal end 36 is connected to a portion of the elongated main support member 2 in proximity to the distal end 4 of the elongated main support member 2 via an elongated extension member 37. The foot support member 34 is oriented perpendicular to the elongated extension member 37 and is adapted to engage the ankles and feet of a user during use.

A seat member 17 is adjustably connected to the center portion 5 of the elongated main support member 2. The seat member 17 is slidably connected to the center portion 5 of the elongated main support member 2 such that the position of the seat member 17 upon the elongated main support member 2 is adjustable linearly. The main support member 2 comprises a series of teeth 39. The seat member comprises on its bottom surface a rearwardly extending seat post member 41. The seat post member 41 has disposed on its bottom end a set of complementary teeth 40. The series of teeth 39 are adapted to engage the complementary teeth 40 so as to retain the seat member 17 in a desired position upon the elongated main support member 2. A seat strap member 18 is attached to the seat member 17 and is adapted to securely and releasably hold a user against the seat member 17 during use.

A back support member 21 includes a back support portion 22 and at least one torso support member 23. The torso support member 23 is a padded semi-circular tube which is adapted to pivot up and down with respect to the longitudinal plane of the back support member 21 and which is also adapted to be raised or lowered according to the needs of the user to ensure proper fit comfortably under the armpit. The torso support member 23 is adapted to engage an arm and armpit of a user such that when the back support member 21 is raised with respect to the seat 17, the back of the user will be stretched. The back support member 21 is releasably and movably connected to the center portion 5 of the elongated main support 2 such that the position of the back support member 21 upon the length of the elongated main support 2 is adjustable. Thus, the user can sit upon the seat member 17, place their torso upon the back support member 21, then adjust the position of the back support member 21 upon the elongated main support member 2 to thereby decompress the back and spine of the user, as will be further discussed in the following paragraphs.

The decompression chair 1 further comprises a back strap member 24 attached to the back support member 21 adapted to securely and releasably hold the user against the back support member 21 during use. A head strap member 25 is attached to a head rest portion 21A adapted to securely and releasably hold the head of a user during use.

The back support portion 22 includes an inflatable neck supporting member 27 adapted to adjustably support the neck of a user during the use of the decompression chair 1. The back support portion 22 is ergonomically shaped and adapted to support the lumbar portion of a user's back.

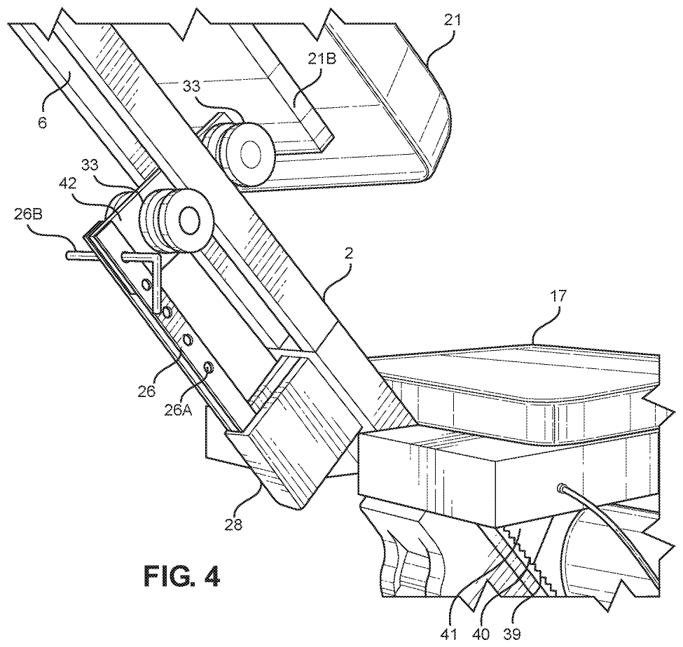

The back support member 21 is movably connected to the center portion 5 of the elongated main support member 2 via a backboard 21B supporting a plurality of spaced roller members 33 (See FIGS. 3 and 4). The spaced roller members 33 are mounted to the backside of the elongated main support member 2 and are adapted to roll as will be further discussed.

The center portion 5 of the elongated main support member 2 includes a recessed track 6 along a substantial portion of its length. The recessed track 6 may be formed as a slot extending through the elongated main supporting member 2. The backboard 21B has a pair of roller bars 42 secured to its rear surface at upper and lower ends thereof. The roller bars 42 are configured to extend through the recessed track 6 of the elongated main support member 2. Each roller bar 42 has at least a pair of spaced rollers 33 mounted thereon and arranged such that a roller 33 is disposed on opposed surfaces of the main support member 2. First and second roller members 7 and 8 in proximity to the distal end 4 of the elongated main support member 2 allow the decompression chair 1 to be rolled away for storage after being folded.

According to an embodiment, the back support member 21 is slidably connected to the center portion 5 of the elongated main support member 2 and releasably and adjustably secured to the center portion 5 of the elongated main support member 2 via a ratchet mechanism 45 attached therebetween as schematically shown in FIG. 2.

In another embodiment (See FIGS. 3 and 4), the back support member 21 is slidably connected to the center portion 5 of the elongated main support member 2 wherein the back support member 21 is releasably and adjustably secured the center portion 5 of the elongated main support member 2 via a linear actuator 28 attached therebetween. The linear actuator 28, i.e. electronic, pneumatic, hydraulic; is mounted to the elongated main support member 2 and has an extending piston member 26 which can be controlled to be selectively raised or lowered. The piston member 26 has a series of holes 26A which are arranged to be aligned with a corresponding hole in the lower roller bar 42. A pin 26B is inserted through one of the series of holes 26A and through the hole of the lower roller bar 42 so as to adjust the back support member 21 at a desired height. With this arrangement, when the piston member 26 is raised or lowered the back support member 21 correspondingly moves therewith. The linear actuator 28 is electrically connected to a linear actuator controller 29 and is adapted to allow a user to control the linear actuator 28 and control the position of the back support member 21 upon the center portion 5 of the elongated main support member 2.

A power source is attached to the elongated main support member 2 and is electrically connected to the linear actuator 28 and linear actuator controller 29 to provide power for its operation. The power source is formed as an electric cable member 31 adapted to be plugged into an external power source. Alternately, the power source may be formed as a rechargeable battery member 32.

The seat member 17 and the back support member 21 each include an electric heating element 38 therein as schematically shown in FIG. 2. The power source is attached to each electric heating element 38 in the back support member 21 and seat member 17 to provide power thereto. The power source is also attached to and provides power to a vibrator member 19 and a massaging mechanism 20 which are also part of the seat member 17.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A decompression chair comprising:
an elongated main support member including:
a length extending between a proximal end and a distal end thereof;
a first stabilizer bar;
wherein said first stabilizer bar has a length between a proximal end and a distal end thereof, is connected to said distal end of said elongated main support member, is oriented perpendicular thereto, and is adapted to engage a supporting surface;
a second stabilizer bar;
wherein said second stabilizer bar has a length between a proximal end and a distal end thereof, is connected to a center portion of said elongated main support member via an elongated extension member, is oriented perpendicular thereto, and is adapted to engage said supporting surface spaced from said first stabilizer bar, to thereby hold said decompression chair in a stable position with respect to said supporting surface;
a seat member;
wherein said seat member is adjustably connected to said center portion of said elongated main support member;
a back support member including:
a back support portion; and
at least one torso support member;
wherein each of said at least one torso support member is adapted to engage one of an arm and armpit of a user;
wherein said back support member is releasably and movably connected to said center portion of said elongated main support member, such that the position of said back support member upon said length of said elongated main support member is adjustable;
wherein said decompression chair is adapted such that said user can sit upon said seat member, place their torso upon said back support member, and then adjust the position of said back support member upon said elongated main support member to thereby decompress their back and spine.

2. The decompression chair of claim 1, wherein said elongated extension member is pivotally connected to said middle portion of said elongated main support member.

3. The decompression chair of claim 1, wherein said seat member is pivotally connected to said center portion of said elongated main support member, such that an angle formed therebetween is adjustable.

4. The decompression chair of claim 1, wherein said seat member is slidably connected to said center portion of said elongated main support member, such that the position of said seat member upon said elongated main support member is adjustable.

5. The decompression chair of claim 1, further comprising a seat strap member attached to said seat member and adapted to securely and releasably hold said user against said seat member during use.

6. The decompression chair of claim 1, further comprising a back strap member attached to said back support member and adapted to securely and releasably hold said user against said back support member during use.

7. The decompression chair of claim 1, further comprising a head strap member attached to said back support member and adapted to securely and releasably hold the head of said user against an upper portion of said back support member during use.

8. The decompression chair of claim 1, further comprising a foot support member having a length between a proximal end and a distal end thereof, is connected to a portion of said elongated main support member in proximity to said distal end of said elongated main support member via an elongated extension member, is oriented perpendicular thereto, and is adapted to engage ankles and feet of said user during use.

9. The decompression chair of claim 1, wherein said back support portion is ergonomically shaped and adapted to support to the lumbar portion of a user's back.

10. The decompression chair of claim 1, wherein said back support member is movably connected to said center portion of said elongated main support member via a plurality of spaced roller members attached to a backside thereof and adapted to roll upon said elongated main support member.

11. The decompression chair of claim 1, wherein said back support member is slidably connected to said center portion of said elongated main support member; and wherein said back support member is releasably and adjustably secured to said center portion of said elongated main support member via a ratchet mechanism attached therebetween.

12. The decompression chair of claim 1, wherein said back support member is slidably connected to said center portion of said elongated main support member; wherein said back support member is releasably and adjustably secured to said center portion of said elongated main support member via a linear actuator attached therebetween; wherein said decompression chair further comprises a linear actuator controller electrically connected to said linear actuator and adapted to allow a user to control said linear actuator and adjust the position of said back support member upon said center portion of said elongated main support member; and wherein said decompression chair further comprises a power source attached to said elongated main support member and electrically connected and adapted to provide electric power to said linear actuator and said linear actuator controller.

13. The decompression chair of claim 12, wherein said power source is formed as an electric cable member adapted to be plugged into an external power source.

14. The decompression chair of claim 12, wherein said power source is formed as a rechargeable battery member.

15. The decompression chair of claim 10, wherein said center portion of said elongated main support member includes a recessed track therein along a substantial portion of said length thereof; and wherein said spaced roller members are attached to a back portion of said back support member and adapted to reside and roll within said recessed track.

16. The decompression chair of claim 1, wherein said elongated main support member further includes a first roller member in proximity to said proximal end, and a second roller member in proximity to said distal end; and wherein said first and second roller members are adapted to allow a user to roll said decompression chair between locations.

17. The decompression chair of claim 1, wherein said seat member and said back support member each include an electric heating element therein; and wherein said decompression chair further comprises a power source attached to said elongated main support member and electrically connected and adapted to provide electric power to said electric heating elements of said seat member and said back support member.

18. The decompression chair of claim 1, wherein said seat member includes a vibrator member therein; and wherein said decompression chair further comprises a power source attached to said elongated main support member and electrically connected and adapted to provide electric power to said vibrator member.

19. The decompression chair of claim 18, wherein said seat member further includes a massaging mechanism therein; and wherein said power source is attached to said massaging mechanism and adapted to provide electric power thereto.

20. The decompression chair of claim 1, wherein said back support portion further includes an inflatable neck supporting member adapted to adjustably support the neck of a use.
